(19) United States
(12) Patent Application Publication
(10) Pub. No.: US 2025/0106664 A1
(43) Pub. Date: Mar. 27, 2025

(54) MEASUREMENT METHOD AND APPARATUS, COMMUNICATION DEVICE, AND STORAGE MEDIUM

(71) Applicant: Beijing Xiaomi Mobile Software Co., LTD., Beijing (CN)

(72) Inventor: Yi XIONG, Beijing (CN)

(73) Assignee: Beijing Xiaomi Mobile Software Co., LTD., Beijing (CN)

(21) Appl. No.: 18/727,857

(22) PCT Filed: Jan. 10, 2022
(86) PCT No.: PCT/CN2022/071002

§ 371 Date: Jul. 10, 2024

(51) Int. Cl. H04W 24/10

(52) U.S. Cl. CPC H04W 24/10

(57) ABSTRACT

A measurement method and apparatus, a communication device, and a storage medium improving the efficiency of the measurements in a wireless communication system. The efficiency of the measurements are improved by: determining, on the basis of the type of a trigger event, a measurement operation of the UE for the trigger event.

### CROSS REFERENCE TO RELATED APPLICATIONS

This application is a National Stage of International Application No. PCT/CN2022/071002, filed on Jan. 10, 2022, the disclosure of which is incorporated herein by reference in its entirety for all purposes.

### TECHNICAL FIELD

The present disclosure relates to, but is not limited to, the communication technology, and in particular, to a measurement method and apparatus, a communication device, and a storage medium.

### BACKGROUND

Generally, for a user equipment (UE), when there exists corresponding measurement configuration and a measurement starting requirement is met, the UE needs to perform measurement of a corresponding measurement object, to obtain a corresponding measurement result for an evaluation of a measurement reporting event or a conditional reconfiguration event.

However, for certain types of events, e.g., a location-based event, or a time-based event, the event may not need to be evaluated according to the measurement result of the corresponding measurement object. If the corresponding measurement is started at this time, it is a waste of measurement opportunities. Moreover, for the measurement reporting or conditional reconfiguration determined by the location-based event combined with a radio resource management (RRM)-based event or by the time-based event combined with an RRM-based event, the measurement reporting or conditional reconfiguration is performed only when both are met at the same time. Therefore, before a location-based or a time-based event configured in combination is met, even if an RRM-based event is met, the UE does not perform the corresponding operation. According to the existing process, the UE needs to perform measurements on the corresponding measurement object when receiving the relevant configuration without considering whether the location-based or time-based event is met, which is also a waste of measurement opportunities.

### SUMMARY

Embodiments of the present disclosure disclose a measurement method and apparatus, a communication device, and a storage medium.

A measurement method is provided according to a first aspect of embodiments of the present disclosure, performed by a UE, which includes:
determining, based on a type of a trigger event, a measurement operation of the UE for the trigger event.

A communication device is provided according to a second aspect of embodiments of the present disclosure, and the communication device includes:
one or more processors; and
a storage for storing instructions executable by the one or more processors;
where the one or more processors are configured to perform the measurement method in any embodiment of the present disclosure when running the executable instructions.

A computer storage medium is provided according to a third aspect of embodiments of the present disclosure, where the computer storage medium stores a computer-executable program, the measurement method in any embodiment of the present disclosure is performed when one or more processors execute the executable program.

It may be understood that the general descriptions above and the detailed descriptions below are merely exemplary and explanatory, and are not intended to limit embodiments of the present disclosure.

### BRIEF DESCRIPTION OF DRAWINGS

FIG. 1 is a schematic diagram of a structure of a wireless communication system.

FIG. 2 is a flow diagram of a measurement method according to an exemplary embodiment of the present disclosure.

FIG. 3 is a flow diagram of a measurement method according to an exemplary embodiment of the present disclosure.

FIG. 4 is a flow diagram of a measurement method according to an exemplary embodiment of the present disclosure.

FIG. 5 is a flow diagram of a measurement method according to an exemplary embodiment of the present disclosure.

FIG. 6 is a flow diagram of a measurement method according to an exemplary embodiment of the present disclosure.

FIG. 7 is a flow diagram of a measurement method according to an exemplary embodiment of the present disclosure.

FIG. 8 is a block diagram of a UE according to an exemplary embodiment.

FIG. 9 is a block diagram of a base station according to an exemplary embodiment.

### DETAILED DESCRIPTION

Embodiments will be described in detail here, examples of which are illustrated in the accompanying drawings. When the following description relates to the accompanying drawings, unless specified otherwise, the same numerals in different drawings represent the same or similar elements. The implementations described in the following exemplary examples do not represent all implementations consistent with the embodiments of the present disclosure. On the contrary, they are examples of an apparatus and a method consistent with some aspects of the present disclosure described in detail in the appended claims.

The terms used in the present disclosure are for the purpose of describing a particular example only, and are not intended to limit the present disclosure. The singular forms such as “a,” “said,” and “the” used in the embodiments of the present disclosure and the appended claims are also intended to include a plural form, unless the context clearly indicates otherwise. It should also be understood that the term “and/or” used herein includes any and all possible combinations of one or more of the items listed in the associated list.

It is to be understood that although different information may be described using the terms such as “first,” “second,” “third,” etc. in the present disclosure, the information should not be limited to these terms. These terms are only used to distinguish information of the same category with each other. For example, a first information may also be referred to as a second information without departing from the scope of the present disclosure, and similarly, a second information may also be referred to as a first information. Depending on the context, the word “if” as used herein may be interpreted as “when” or “upon” or “in response to determining”.

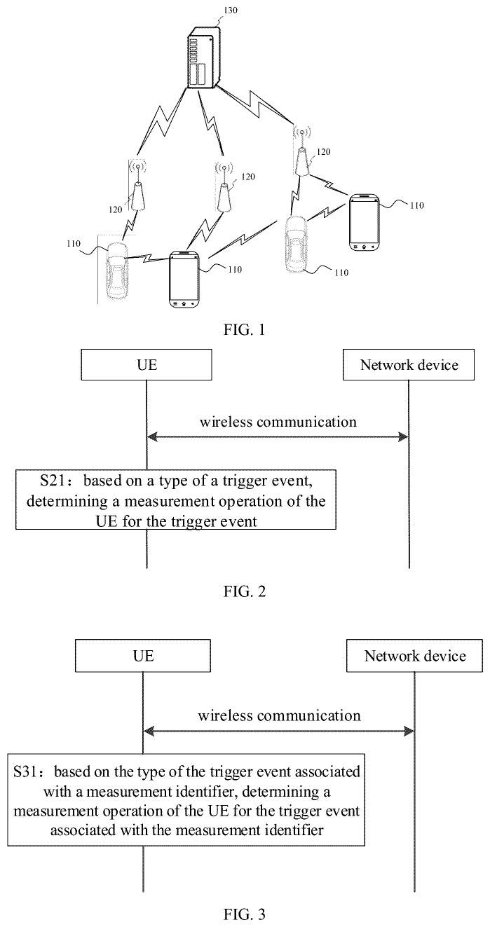

Please refer to FIG. 1, which illustrates a schematic diagram of a structure of a wireless communication system provided in an embodiment of the present disclosure. As illustrated in FIG. 1, the wireless communication system is a communication system based on cellular mobile communication technology, and the wireless communication system may include: a plurality of UEs 110 and a plurality of base stations 120.

The UE 110 may refer to a device that provides voice and/or data connectivity to a user. The UE 110 may communicate, via a radio access network (RAN) with one or more core networks. The UE 110 may be an Internet of Things (IoT) UE, e.g., a sensor device, a mobile phone (or a “cellular” phone), and a computer with an IoT UE, for example, it may be a fixed, portable, pocket-sized, handheld, computer built-in, or vehicle-mounted apparatus. For example, it is a station (STA), a subscriber unit, a subscriber station, a mobile station, a mobile, a remote station, an access point, a remote terminal, an access terminal, a user terminal, a user agent, a user device, or a UE. Alternatively, the UE 110 may also be a device of an unmanned aerial vehicle. Alternatively, the UE 110 may also be a vehicle-mounted device, for example, it may be a vehicle computer with wireless communication function, or a wireless user device connected to an external vehicle computer. Alternatively, the UE 110 may also be a roadside device, for example, a street lamp, a traffic light, or other roadside devices with wireless communication functionality.

The base station 120 may be a network-side device in a wireless communication system. The wireless communication system may be a 4th generation mobile communication (4G) system, also referred to as the long term evolution (LTE) system, or, the wireless communication system may be a fifth generation mobile communication network (5G) system, also referred to as a new radio system or a 5G New Radio (NR) system. Alternatively, the wireless communication system may be a next generation system of the 5G system. Wherein the access network in the 5G system may be referred to as a new generation-radio access network (NG-RAN).

The base station 120 may be an evolved base station (eNB) adopted in a 4G system. Alternatively, the base station 120 may be a base station (gNB) adopting a central and distributed architecture in a 5G system. If the base station 120 adopts a central and distributed architecture, it usually includes a central unit (CU) and at least two distributed units (DUs). The central unit is provided with a protocol stack for the packet data convergence protocol (PDCP) layer, the radio link layer control (RLC) layer, and the medium access control (MAC) layer. The distributed unit is provided with the physical (PHY) layer protocol stack. The specific implementations of the base station 120 are not limited in embodiments of the present disclosure.

Between the base station 120 and the UE 110, a wireless connection may be established via a wireless air interface. In various embodiments, the wireless air interface is a wireless air interface based on the 4G standard; or, the wireless air interface is a wireless air interface based on the 5G standard, e.g., the wireless air interface is a new radio; or, the wireless air interface may also be a wireless air interface based on the technology standard of a next generation mobile communication network of 5G.

In some embodiments, an end to end (E2E) connection may also be established between the user devices 110. For example, the scenarios are vehicle to vehicle (V2V) communication, vehicle to infrastructure (V2I) communication, and vehicle to pedestrian (V2P) communication in vehicle to everything (V2X) communication, etc.

Here, the above-mentioned UE may be considered as the terminal equipment in the following embodiments.

In some embodiments, the wireless communication system may further include a network management device 130.

Several base stations 120 are respectively connected to a network management device 130. Wherein the network management device 130 may be a core network device in the wireless communication system, for example, the network management device 130 may be the Mobility Management Entity (MME) in the Evolved Packet Core (EPC). Alternatively, the network management device may also be other core network devices, such as a serving gateway (SGW), a public data network gateway (PGW), a policy and charging rules function (PCRF) unit, or a home subscriber server (HSS), etc. The implementation form of the network management device 130 is not limited in the embodiments of the present disclosure.

In order to facilitate the understanding of those skilled in the art, embodiments of the present disclosure list a plurality of implementations to clearly illustrate the technical solutions of the embodiments of the present disclosure. Certainly, those skilled in the art may understand that, the plurality of embodiments provided in the embodiments of the present disclosure may be executed individually, or may be executed together with the methods of other embodiments in the embodiments of the present disclosure, or may be executed alone or in combination with some methods in other related technologies, which is not limited in the embodiments of the present disclosure.

In order to better understand the method described in any embodiment of the present disclosure, the measurement related contents are first partially explained as below.

In an embodiment, a trigger event of conditional handover (CHO) includes: conditional event A3 and/or conditional event A5, where conditional event A3 indicates that the measurement result of a conditional reconfiguration candidate cell is better than the given threshold for the measurement result of the serving cell; conditional event A5 indicates that the measurement result of the serving cell is greater than a threshold1, and the measurement result of the conditional reconfiguration candidate cell is less than a threshold2.

In another embodiment, a trigger event of CHO includes: conditional event A4 indicating that the measurement result of the conditional reconfiguration candidate cell is greater than a threshold.

In an embodiment, the following trigger event of CHO is introduced in the Non Terrestrial Network (NTN): a location-based event and/or a time-based event, where the location-based event indicates that the distance between the UE and the reference location of the serving cell is greater than a threshold1, and the distance between the UE and the reference location of the conditional reconfiguration candidate cell is less than a threshold2; the time-based event indicates that the time measured by the UE is greater than a threshold1 and less than a threshold2 or at least the time measured by the UE is within a certain time range.

In an embodiment, the entering condition of the location-based event may be: Ml1+Hys>Thresh1 and M12+Hys<Thresh2. Here, Ml1 represents the distance between the UE and the reference location of the serving cell, Ml2 represents the distance between the UE and the reference location of the neighboring cell, i.e., the conditional reconfiguration candidate cell, Hys represents the hysteresis value, Thresh1 represents the threshold value1, and Thresh2 represents the threshold value2.

In an embodiment, the entering condition of the time-based event may be: Mt>Thresh1, and the leaving condition of the time-based event may be: Mt>Thresh1+Duration. Here, Mt represents the measurement time of the UE, Duration represents the duration parameter, and Thresh1 represents the threshold value1. Thresh2 is equal to Thresh1+Duration, i.e., the measurement time range corresponding to the time-based event is from Thresh1 to Thresh1+Duration.

As illustrated in FIG. 2, a measurement method is provided by embodiments of the present disclosure, performed by a UE, which includes:

In step S21: based on a type of a trigger event, determining a measurement operation of the UE for the trigger event.

Here, UE may be various terminals, for example, it may be, but not limited to, a mobile phone, a computer, a server, a wearable device, a game control platform, or a multimedia device, etc.

A measurement method is provided by embodiments of the present disclosure, performed by a UE, which may include: acquiring a type of a trigger event.

For example, the UE receives reporting configuration information from a network device, where the reporting configuration information includes the type of the trigger event, and the UE acquires the type of the trigger event based on the reporting configuration information. Here, the reporting configuration information may be, but not limited to: configuration information related to measurement reporting and/or configuration information related to conditional reconfiguration.

Here, the network device may be an access network device or a core network device. The access network device may be various base stations, for example, it may be, but not limited to, a 2G base station, a 3G base station, a 4G base station, a 5G base station, or other eNBs. The core network device may be various network functions (NF), for example, it may be the Access and Mobility Management Function (AMF). If the UE receives the reporting configuration information from a core network device, it may be that: the core network device sends the reporting configuration information to the base station, and the base station sends the reporting configuration information to the UE.

For example, the UE may acquire a type of trigger events from the stored information.

The types of trigger events may include one or more types of trigger events. If there are a plurality of types of trigger events, the plurality of types of trigger events may be carried in one piece of reporting configuration information or may also be carried in a plurality of pieces of reporting configuration information. In some embodiments of the present disclosure, plurality refers to two or more.

In some embodiments, the trigger event may include, but is not limited to, at least one of the following:
a trigger event for conditional reconfiguration; and
a trigger event for measurement reporting.

In some embodiments, the type of a trigger event may include, but is not limited to, at least one of the following:
a type of a trigger event for conditional reconfiguration; and
a type of a trigger event for measurement reporting.

The conditional reconfiguration includes but is not limited to at least one of the following:
CHO;
Conditional PSCell Change (CPC); and
Conditional PSCell Addition (CPA).

The primary secondary cell (PSCell) includes but is not limited to a primary cell (PCell) or a secondary cell (SCell).

The measurement reporting includes: periodic measurement reporting or event-triggered measurement reporting.

The type of a trigger event for conditional reconfiguration and the type of a trigger event for measurement reporting may both include, but are not limited to, at least one of the following: a radio resource management (RRM)-based event, a time-based events, and a location-based events. Here, a location-based event may also refer to a distance-based event. Here, an RRM-based event may also refer to an event based on an RRM measurement result.

The type of a trigger event for conditional reconfiguration includes but is not limited to at least one of the following: a conditional reconfiguration event based on RRM, a conditional reconfiguration event based on location, and a conditional reconfiguration event based on time.

The type of a trigger event for measurement reporting includes but is not limited to at least one of the following: a measurement reporting event based on RRM, a measurement reporting event based on location, and a measurement reporting event based on time.

The measurement reporting event based on RRM includes but is not limited to at least one of the following:

Event A1, indicating that the measurement result of the serving cell is greater than a threshold;

Event A2, indicating that the measurement result of the serving cell is less than a threshold;

Event A3, indicating that the measurement result of the neighboring cell is better than a given threshold value for the measurement result of the serving cell;

Event A4, indicating that the measurement result of the neighboring cell is greater than a threshold;

Event A5, indicating that the measurement result of the serving cell is less than a threshold1, and the measurement result of the neighboring cell is greater than a threshold2.

Event A6, indicating that the measurement result of the neighboring cell is better than the measurement result of the secondary serving cell;

Event B1, indicating that the measurement result of the inter-RAT neighboring cell is greater than a threshold;

Event B2, indicating that the measurement result of the primary serving cell is less than a threshold1, and the measurement result of the inter-RAT neighboring cell is greater than a threshold2.

Here, a serving cell includes but is not limited to a PCell, a SCell, and/or a PSCell.

The conditional reconfiguration event based on RRM includes but is not limited to at least one of the following:
Event A3: indicating that the measurement result of the conditional reconfiguration candidate cell is better than a given threshold value for the measurement result of the serving cell;
Event A4; indicating that the measurement result of the conditional reconfiguration candidate cell is greater than a threshold;
Event A5, indicating that the measurement result of the serving cell is greater than a threshold1, and the measurement result of the conditional reconfiguration candidate cell is less than a threshold2.

Here, a candidate cell includes but is not limited to a candidate PCell, a candidate SCell, and/or a candidate PSCell.

In some embodiments, a candidate cell may be a candidate neighboring cell.

In other embodiments, a candidate cell may be a candidate neighboring cell and a candidate serving cell.

The location-based measurement reporting event includes, Event D1 indicating that the distance between the UE and the reference location of the serving cell is greater than a threshold1, and the distance between the UE and the reference location of the neighboring cell is less than a threshold2.

The location-based conditional reconfiguration event includes, Event D1 indicating that the distance between the UE and the reference location of the serving cell is greater than a threshold1, and the distance between the UE and the reference location of the conditional reconfiguration candidate cell is less than a threshold2.

The time-based measurement reporting event includes: Event T1 indicating that the time measured by the UE is greater than a threshold1 and less than a threshold2.

In some embodiments, the time measured by the UE may be the current time.

The time-based conditional reconfiguration event includes: Event T1 indicating that the time measured by the UE is greater than a threshold1 and less than a threshold2.

In some embodiments, the time measured by the UE may be the current time.

In some embodiments, the type of a trigger event may include, but is not limited to, at least one of the following:
an RRM-based event;
a time-based event; and
a location-based event.

The RRM-based event includes but is not limited to an RRM-based measurement reporting event and/or an RRM-based conditional reconfiguration event.

The location-based event includes but is not limited to a location-based measurement reporting event and/or a location-based conditional reconfiguration event.

The time-based event includes but is not limited to a time-based measurement reporting event and/or a time-based conditional reconfiguration event.

In the step S21, determining a measurement operation of the UE for the trigger event includes: determining that the UE performs a measurement operation for the trigger event, or determining that the UE does not perform a measurement operation for the trigger event.

In some embodiments, a measurement operation for the trigger event includes at least one of the following:
a measurement operation determined based on reporting configuration information;
a measurement operation of a measurement object associated with reporting configuration information;
where the reporting configuration information contains a configuration of the trigger event.

The measurement operation determined based on the reporting configuration information includes but is not limited to: a measurement operation corresponding to a measurement reference signal needing to be measured and determined according to the reporting configuration information, and/or a measurement operation corresponding to a measurement quantity needing to be measured and determined according to the reporting configuration information. Here, the measurement reference signal includes but is not limited to the synchronization signal block (SSB) and/or the channel state information reference signal (CSI-RS). Here, the measurement quantity includes but is not limited to the reference signal received power (RSRP), the reference signal received quality (RSRQ), and/or the signal to interference plus noise ratio (SINR).

Illustratively, if the UE receives reporting configuration information including the configuration of the trigger event, the UE may determine whether to perform a measurement operation of the measurement reference signal and/or the measurement quantity needing to be measured and determined based on the reporting configuration information. For example, if the UE determines, based on the reporting configuration information, that the configuration of the trigger event is an RRM-based event, and the measurement reference signal included in the reporting configuration information is SSB and the included measurement quantity is RSRP, the UE may perform a measurement operation of measuring the RSRP of the SSB.

The measurement object may be defined as below.

The measurement object specifies information that, the UE is suitable for SSB intra-frequency or inter-frequency measurements, and/or CSI-RS intra-frequency or inter-frequency measurements.

If the reporting configuration information includes information indicating a measurement reference signal needing to be measured, the UE may perform and/or not perform a measurement operation of the measurement reference signal.

In the embodiments of the present disclosure, based on a type of a trigger event, a measurement operation of a UE for the trigger event may be determined by the UE. Such approach may not necessarily always evaluate the trigger event according to the measurement result, i.e., the UE does not necessarily always perform measurement of the corresponding trigger event and resulting in a waste of measurement opportunities, it may reduce the measurement opportunities for a measurement object associated with a trigger event, and increase the measurement opportunities for other measurement objects that need to be measured, thereby improving the efficiency of the measurement. In addition, embodiments of the present disclosure may also enable the UE to flexibly determine, according to the type of the trigger event, whether it is necessary to perform a measurement operation for the trigger event.

It should be noted that, those skilled in the art may understand that, the method provided in the embodiments of the present disclosure may be executed individually, or may be executed together with some methods in the embodiments of the present disclosure or some methods in related technologies.

Step S21 includes: based on the type of the trigger event associated with a measurement identifier, determining a measurement operation of the UE for the trigger event associated with the measurement identifier.

Wherein the type of the trigger event associated with a measurement identifier may be the type of the trigger event included in the reporting configuration associated with the measurement identifier.

As illustrated in FIG. 3, a measurement method is provided in embodiments of the present disclosure, performed by a UE, which includes:

In step S31: based on the type of the trigger event associated with a measurement identifier, determining a measurement operation of the UE for the trigger event associated with the measurement identifier.

In some embodiments of the present disclosure, the type of the trigger event may be the type of the trigger event in step S21, and a measurement operation for the trigger event may be the measurement operation for the trigger event in step S21.

The configuration of the measurement identifier may be carried in measurement configuration information. For example, the UE receives the measurement configuration information from the network device, where the measurement configuration information is configuration information including a measurement identifier.

Here, the measurement configuration information includes a measurement identifier, and a measurement object identifier and/or a reporting configuration identifier associated with the measurement identifier. Here, the reporting configuration identifier is used to identify the reporting configuration information. Here, the measurement object identifier is used to identify the measurement object. The measurement identifier, the measurement object identifier, and the reporting configuration identifier may all be one or more predetermined bits.

Here, a measurement identifier may be associated with a measurement object identifier or a reporting configuration identifier. If a measurement identifier is associated with a measurement object identifier, the measurement identifier may be associated with a measurement object; and if the measurement identifier is associated with a reporting configuration identifier, the measurement object may be associated with a piece of reporting configuration information.

The measurement identifier may also be acquired by the UE in other manners. For example, the UE may acquire, from stored information, a measurement identifier and/or measurement configuration information including a measurement identifier.

The measurement identifier is associated with a type of a trigger event. For example, a measurement identifier may be associated with one or more trigger events, and the trigger events have the same or different types.

The measurement identifier is associated with a measurement object and/or reporting configuration information. For example, the measurement identifier may be associated with a measurement object or a piece of reporting configuration information. For another example, a measurement identifier may be associated with a measurement object and a piece of reporting configuration information.

A measurement operation for the trigger event associated with the measurement identifier includes at least one of the following:
a measurement operation determined by reporting configuration information associated with the measurement identifier, where the reporting configuration information includes a configuration of the trigger event; and
a measurement operation of a measurement object associated with the measurement identifier, where the measurement object is associated with the trigger event, or the measurement object is associated with the reporting configuration information including a configuration of the trigger event.

A measurement operation for the trigger event associated with the measurement identifier may further include a measurement operation based on both reporting configuration information and a measurement object that are associated with the measurement identifier.

A measurement operation determined by reporting configuration information associated with the measurement identifier includes but is not limited to: a measurement operation corresponding to a measurement reference signal needing to be measured and determined according to the reporting configuration information associated with the measurement identifier and/or a measurement operation corresponding to a measurement quantity needing to be measured and determined according to the reporting configuration information. Here, the measurement reference signal may be a measurement reference signal in the above embodiments, and the measurement quantity may be a measurement quantity in the above embodiments.

A measurement operation of a measurement object associated with the measurement identifier includes but is not limited to: a measurement operation of a frequency point, a cell, and/or a measurement reference signal associated with the measurement identifier.

Illustratively, the UE stores measurement identifiers and the configuration of the trigger events associated therewith, and the UE may determine, based on an acquired measurement identifier, the type of the trigger event associated with the measurement identifier. For example, the UE determines that the type of the trigger event associated with the measurement identifier is an RRM event.

A measurement operation of a trigger event associated with the measurement identifier includes but is not limited to: a measurement operation of the cell-level measurement and/or a measurement operation of the beam-level measurement. For example, the measurement operation of the trigger event for conditional reconfiguration associated with the measurement identifier may be a frequency measurement of a certain candidate cell corresponding to CHO, CPC or CPA. For example, the measurement operation of the trigger event for conditional reconfiguration associated with the measurement identifier may be a measurement of the measurement object corresponding to a certain candidate cell.

In the embodiments of the present disclosure, based on the type of the trigger event associated with a measurement identifier, a measurement operation of the UE for the trigger event associated with the measurement identifier may be determined by the UE. As such, the embodiments of the present disclosure may not necessarily always evaluate the trigger event associated with the measurement identifier according to the measurement result, i.e., it is not necessary to always perform the measurement for the trigger event associated with the measurement identifier, which may reduce the measurement opportunities for a measurement object associated with the measurement identifier, thus increase the measurement opportunities for other measurement objects that need to be measured, thereby improving the efficiency of the measurement. In addition, the embodiments of the present disclosure may also enable the UE to flexibly determine, according to the type of the trigger event associated with the measurement identifier, whether it is necessary to perform a measurement operation for the trigger event associated with the measurement identifier.

It should be noted that, those skilled in the art may understand that, the method provided in the embodiments of the present disclosure may be executed individually, or may be executed together with some methods in the embodiments of the present disclosure or some methods in related technologies.

The step S21 includes one of the following:
based on that the type of the trigger event for conditional reconfiguration is an RRM-based event, determining that the UE performs a measurement operation for the trigger event; and
based on that the type of the trigger event for conditional reconfiguration is not an RRM-based event, determining that the UE does not perform a measurement operation for the trigger event.

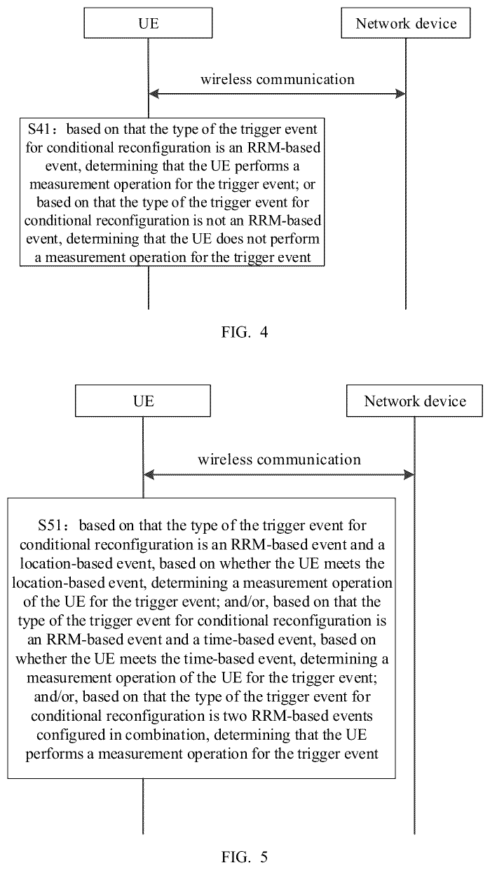

As illustrated in FIG. 4, a measurement method is provided in embodiments of the present disclosure, performed by a UE, which includes:

In step S41: based on that the type of the trigger event for conditional reconfiguration is an RRM-based event, determining that the UE performs a measurement operation for the trigger event; or based on that the type of the trigger event for conditional reconfiguration is not an RRM-based event, determining that the UE does not perform a measurement operation for the trigger event.

In some embodiments of the present disclosure, the type of trigger event for conditional reconfiguration is the type of trigger event for conditional reconfiguration in the above embodiments; the measurement operation for the trigger event is the measurement operation for the trigger event in step S21; and the RRM-based event is the RRM-based conditional reconfiguration event in the above embodiments.

The embodiments of the present disclosure provides a measurement method, performed by a UE, which may include: based on that the type of the trigger event for conditional reconfiguration associated with the measurement identifier is an RRM-based event, determining that the UE performs a measurement operation for the trigger event associated with the measurement identifier; or based on that the type of the trigger event for conditional reconfiguration associated with the measurement identifier is not an RRM-based event, determining that the UE does not perform a measurement operation for the trigger event associated with the measurement identifier.

The type of the trigger event for conditional reconfiguration is not an RRM-based event includes but is not limited to at least one of the following:
the type of the trigger event for conditional reconfiguration is a location-based event; and
the type of the trigger event for conditional reconfiguration is a time-based event.

In some embodiments of the present disclosure, a location-based event is a location-based conditional reconfiguration event in the above embodiments; a distance-based event is a distance-based conditional reconfiguration event in the above embodiments; and a time-based event is a time-based conditional reconfiguration event in the above embodiments.

For example, if the UE determines that the type of the trigger event for conditional reconfiguration is a location-based event or a distance-based event, it is determined that the UE does not perform a measurement operation for the trigger event.

For example, if the UE determines that the type of the trigger event for conditional reconfiguration is a time-based event, it is determined that the UE does not perform a measurement operation for the trigger event.

For example, for each measurement identifier (measId) included in the measurement identifier list (measIdList) in the measurement configuration (VarMeasConfig):
if the reporting type (reportType) of the associated reporting configuration (reportConfig) is periodic measurement reporting, event-triggered measurement reporting, and/or,
if the reporting type of the associated reporting configuration is the trigger configuration of conditional reconfiguration (condTriggerConfig), and the event type (condEventId) includes: conditional event A3 and/or conditional event A4 and/or conditional event A5;
the measurement is performed.

Here, the measurement configuration may be the measurement configuration information stored in the UE; the reporting configuration may be the reporting configuration information in the above embodiments; and the reporting type includes but is not limited to periodic measurement reporting, event-triggered measurement reporting, and/or trigger configuration of conditional reconfiguration. Here, the trigger configuration of conditional reconfiguration may be the configuration of the trigger event for the conditional reconfiguration in the above embodiments; and the event type may be the type of the trigger event for conditional reconfiguration in the above embodiments.

In the embodiments of the present disclosure, the determination of whether to perform a measurement operation for the trigger event may be made by determining, through the UE, whether the type of the trigger event for conditional reconfiguration is an RRM-based event; in case of determining that the type of the trigger event for conditional reconfiguration is an RRM-based event, it is determined to perform a measurement operation for the trigger event; in case of determining that the type of the trigger event for conditional reconfiguration is not an RRM-based event, i.e., a time-based event, or a location-based or distance-based event, it is determined not to perform a measurement operation for the time-based event, or the location-based or distance-based event. As such, the measurement opportunities of the UE may be flexibly adjusted. For example, if an RRM-based conditional reconfiguration event is configured, the measurement for the RRM-based conditional reconfiguration event may be directly performed; if a time-based or location-based or distance-based conditional reconfiguration event is configured, the measurement for the time-based or location-based or distance-based conditional reconfiguration event is not performed, so as to increase measurement opportunities for other measurement objects that need to be measured.

It should be noted that, those skilled in the art may understand that, the method provided in the embodiments of the present disclosure may be executed individually, or may be executed together with some methods in the embodiments of the present disclosure or some methods in related technologies.

The step S21 includes at least one of the following:
based on that the type of the trigger event for conditional reconfiguration is an RRM-based event and a location-based event, in response to whether the UE meets the location-based event, determining a measurement operation of the UE for the trigger event;
based on that the type of the trigger event for conditional reconfiguration is an RRM-based event and a time-based event, in response to whether the UE meets the time-based event, determining a measurement operation of the UE for the trigger event; and
based on that the type of the trigger event for conditional reconfiguration is an RRM-based event and that the type of the trigger event configured in combination with the RRM-based event is an RRM-based event, determining the UE performs a measurement operation for the trigger event.

As illustrated in FIG. 5, a measurement method is provided in embodiments of the present disclosure, performed by a UE, which includes:

In step S51: based on that the type of the trigger event for conditional reconfiguration is an RRM-based event and a location-based event, in response to whether the UE meets the location-based event, determining a measurement operation of the UE for the trigger event; and/or, based on that the type of the trigger event for conditional reconfiguration is an RRM-based event and a time-based event, in response to whether the UE meets the time-based event, determining a measurement operation of the UE for the trigger event; and/or, based on that the type of the trigger event for conditional reconfiguration is two RRM-based events configured in combination, determining that the UE performs a measurement operation for the trigger event.

In some embodiments of the present disclosure, the type of trigger event for conditional reconfiguration is the type of trigger event for conditional reconfiguration in the above embodiments; the measurement operation for the trigger event is the measurement operation for the trigger event in step S21; and the RRM-based event is the RRM-based conditional reconfiguration event in the above embodiments. A location-based event is a location-based conditional reconfiguration event in the above embodiments; a distance-based event is a distance-based conditional reconfiguration event in the above embodiments; and a time-based event is a time-based conditional reconfiguration event in the above embodiments.

The embodiments of the present disclosure provides a measurement method, performed by a UE, which may include: based on that the type of the trigger event for conditional reconfiguration associated with the measurement identifier is an RRM-based event and a location-based event, in response to whether the UE meets the location-based event, determining a measurement operation of the UE for conditional reconfiguration associated with the measurement identifier; based on that the type of the trigger event for conditional reconfiguration associated with the measurement identifier is an RRM-based event and a time-based event, in response to whether the UE meets the time-based event, determining a measurement operation of the UE for the trigger event; and/or, based on that the type of the trigger event for conditional reconfiguration associated with the measurement identifier is an RRM-based event and that the type of the trigger event configured in combination with the RRM-based event is an RRM-based event, determining that the UE performs a measurement operation for the trigger event.

The step S21 may include: based on the type of the trigger event for conditional reconfiguration and the type of the trigger event configured in combination with the trigger event for conditional reconfiguration, determining a measurement operation of the UE for the trigger event.

The embodiments of the present disclosure provides a measurement method, performed by a UE, which includes: based on the type of the trigger event for conditional reconfiguration and the type of the trigger event configured in combination with the trigger event for conditional reconfiguration, determining a measurement operation of the UE for the trigger event.

The type of the trigger event configured in combination with the trigger event for conditional reconfiguration may include, but is not limited to, at least one of the following:
an RRM-based event;
a location-based or distance-based event; and
a time-based event.

The type of the trigger event for conditional reconfiguration and the type of the trigger event configured in combination with the trigger event for conditional reconfiguration includes but is not limited to one of the following:
based on that the type of the trigger event for conditional reconfiguration is an RRM-based event and a time-based event configured in combination;
based on that the type of the trigger event for conditional reconfiguration is an RRM-based event and a location-based or distance-based event configured in combination;
based on that the type of the trigger event for conditional reconfiguration is two RRM-based events configured in combination.

The embodiments of the present disclosure provides a measurement method, performed by a UE, which may include: based on that the type of the trigger event for conditional reconfiguration is an RRM-based event and that the type of the trigger event configured in combination with the RRM-based event is a time-based event, in response to whether the UE meets the time-based event, determining a measurement operation of the UE for the trigger event. Here, that the type of the trigger event for conditional reconfiguration is an RRM-based event and the type of the trigger event configured in combination with the RRM-based event is a time-based event means that the type of the trigger event for conditional reconfiguration is an RRM-based event and a time-based event configured in combination.

The embodiments of the present disclosure provides a measurement method, performed by a UE, which may include: based on that the type of the trigger event for conditional reconfiguration is an RRM-based event and that the type of the trigger event configured in combination with the RRM-based event is a location-based event, in response to whether the UE meets the location-based event, determining a measurement operation of the UE for the trigger event. Here, that the type of the trigger event for conditional reconfiguration is an RRM-based event and the type of the trigger event configured in combination with the RRM-based event is a location-based event means that the type of the trigger event for conditional reconfiguration is an RRM-based event and a location-based event configured in combination.

As such, the embodiments of the present disclosure may, based on the type of trigger event for conditional reconfiguration configured in combination with an RRM-based event, e.g., a time-based event, a location-based event, or an RRM-based event, determine whether to perform a measurement operation for a trigger event.

Here, that the type of the trigger event for conditional reconfiguration is two RRM-based events configured in combination includes: the type of the trigger event based on conditional reconfiguration is an RRM-based event and the type of the trigger event configured in combination with the RRM event is an RRM-based event.

The embodiments of the present disclosure provides a measurement method, performed by a UE, which may include: based on that the type of the trigger event for conditional reconfiguration is an RRM-based event and that the type of the trigger event configured in combination with the RRM-based event is an RRM-based event, determining that the UE performs a measurement operation for the measurement event.

As such, in the embodiment of the present disclosure, if the type of the trigger event for conditional reconfiguration is an RRM-based event, and the type of the trigger event configured in combination with the RRM-based event is also an RRM-based event, it is directly determined that the UE performs a measurement operation for the trigger event. As such, if an RRM-based event is combined with another RRM-based event, it may be ensured that the measurement operation for the trigger event is performed, and the measurement efficiency may be improved.

In response to whether the UE meets the location-based event, determining a measurement operation of the UE for the trigger event includes one of the following:
in response to that the UE meets the location-based event, determining that the UE performs a measurement operation for the trigger event;
in response to that the UE does not meet the location-based event, determining that the UE does not perform a measurement operation for the trigger event.

For example, if the UE determines that the type of the trigger event for conditional reconfiguration is an RRM-based event and a location-based event, and the UE meets the location-based event, a measurement operation for the RRM-based event and/or the location-based event is performed. Alternatively, if the UE determines that the type of the trigger event for conditional reconfiguration is an RRM-based event and a location-based event, and the UE does not meet the location-based event, a measurement operation for the location-based event is not performed and/or a measurement operation for the RRM-based event is not performed.

For example, the UE determines that the type of the trigger event for conditional reconfiguration is conditional event A3, and the trigger event configured in combination with the conditional event is conditional event D1. If the UE determines that conditional event D1 is met, the measurement operation for conditional event D1 and conditional event A3 is performed; if the UE determines that conditional event D1 is not met, the measurement operation for conditional event D1 is not performed and/or the measurement operation of conditional event A3 is not performed.

In response to whether the UE meets the time-based event, determining a measurement operation of the UE for the trigger event includes one of the following:
in response to that the UE meets the time-based event, determining that the UE performs a measurement operation for the trigger event;
in response to that the UE does not meet the time-based event, determining that the UE does not perform a measurement operation for the trigger event.

For example, if the UE determines that the type of the trigger event for conditional reconfiguration is an RRM-based event and a time-based event, and the UE meets the time-based event, a measurement operation for the RRM-based event and/or the time-based event is performed. Alternatively, if the UE determines that the type of the trigger event for conditional reconfiguration is an RRM-based event and a time-based event, and the UE does not meet the time-based event, a measurement operation for the time-based event is not performed and/or a measurement operation for the RRM-based event is not performed.

For example, the UE determines that the type of trigger event for conditional reconfiguration is conditional event A4, and the trigger event configured in combination with the conditional event is conditional event T1. If the UE determines that conditional event T1 is met, the measurement operation for conditional event T1 and conditional event A4 is performed; if the UE determines that conditional event T1 is not met, the measurement operation for conditional event T1 is not performed and/or the measurement operation of conditional event A4 is not performed.

Base on that the type of the trigger event for conditional reconfiguration is an RRM-based event and whether the UE meets the trigger event configured in combination with the RRM-based event, determining a measurement operation of the UE for the conditional reconfiguration trigger event.

For example, for each measurement identifier (measId) included in the measurement identifier list (measIdList) in the measurement configuration (VarMeasConfig):
if the reporting type (reportType) of the associated reporting configuration (reportConfig) is periodic measurement reporting, event-triggered measurement reporting, and/or,
if the reporting type of the associated reporting configuration is the trigger configuration for conditional reconfiguration (condTriggerConfig), and the event type (condEventId) includes: conditional event A3 and/or conditional event A4 and/or conditional event A5; and/or,
if the event of other measIds associated with the same conditional reconfiguration as the measId is met;
measurement is performed.

Here, that the event of other measIds associated with the same conditional reconfiguration as the measId is met means that other trigger events configured in combination with the trigger event are all met. That is, in the combined configuration, if other trigger events configured in combination with the trigger event are all met, measurement may be performed.

Here, being associated with the same conditional reconfiguration may be that a plurality of measurement identifiers are included in the same conditional reconfiguration, and/or being associated with the same conditional reconfiguration identifier, and/or being associated with the same candidate cell configuration.

For example, if the UE determines that the type of the trigger event for conditional reconfiguration is an RRM-based event, and the type of the trigger event configured in combination with the RRM-based event is also an RRM-based event, for example, the UE determines that the type of the trigger event for conditional reconfiguration is conditional event A3, and the trigger event configured in combination with conditional event A3 is conditional event A4, the UE may perform a measurement operation for conditional event A3 and/or a measurement operation for conditional event A4.

For example, for each measurement identifier (measId) included in the measurement identifier list (measIdList) in the measurement configuration (VarMeasConfig):
if the reporting type (reportType) of the associated reporting configuration (reportConfig) is periodic measurement reporting, event-triggered measurement reporting, and/or,
if the reporting type of the associated reporting configuration is the trigger configuration for conditional reconfiguration (condTriggerConfig), and the event type (condEventId) includes: conditional event A3 and/or conditional event A4 and/or conditional event A5; and/or
if the events of other measIds associated with the same conditional reconfiguration as the measId are condition event A3 and/or condition event A4 and/or condition event A5;
the measurement is performed.

As such, in the embodiments of the present disclosure, based on the type of the trigger event for conditional reconfiguration and the type of the trigger event configured in combination with the trigger event for conditional reconfiguration, a measurement operation of the UE for the trigger event may be accurately determined.

If the type of trigger event for conditional reconfiguration is an RRM-based event, and the trigger event configured in combination with the RRM-based event is a time-based or location-based event, it will be also considered whether the UE meets the time-based or location-based event, to determine whether to perform a measurement operation for the trigger event. As such, in response to a configuration combining an RRM-based event with a time-based event, or combining an RRM-based event with a location-based event, the measurement operation may be performed only if the time-based event is met or the location-based event is met, and the measurement operation is not performed if the time-based event is not met or the location-based event is not met, therefore such approach may reduce the probability of still performing the measurement operation if the time-based event or the location-based event conditions are not met, thereby reducing the waste of measurement opportunities, increasing opportunities for other measurement that need to be measured, and then improving measurement efficiency.

In an embodiment, if the type of trigger event for conditional reconfiguration is an RRM-based event, and the type of the trigger event configured in combination with the RRM-based event is a time-based event, it indicates that the RRM-based event and the time-based event are associated in the same piece of configuration information for conditional reconfiguration, i.e., being associated with the same conditional reconfiguration candidate cell, and corresponding to the same conditional reconfiguration identifier (ID). For example, the UE receives configuration information for conditional reconfiguration, and a first predetermined bit of the configuration information for conditional reconfiguration corresponding to the conditional reconfiguration identifier indicates the information associated with an RRM-based event (e.g., the measurement identifier corresponding to the RRM-based event configuration) and the second predetermined bit indicates the information associated with a time-based event (e.g., the measurement identifier corresponding to the time-based event configuration).

In another embodiment, if the type of trigger event for conditional reconfiguration is an RRM-based event, and the type of the trigger event configured in combination with the RRM-based event is a time-based event, it indicates that the information of the RRM-based event and the time-based event may also be carried in different or the same reporting configuration information, or that the information of the RRM-based event and the time-based event may also be carried in different configuration information for conditional reconfiguration.

For example, the type of trigger event for conditional reconfiguration is conditional event A3, the trigger event configured in combination with the conditional event A3 may be conditional event T1.

In an embodiment, if the type of trigger event for conditional reconfiguration is an RRM-based event, and the type of the trigger event configured in combination with the RRM-based event is a location-based event, it indicates that information of the RRM-based event and the location-based event are associated in the same piece of configuration information for conditional reconfiguration, i.e., being associated with the same conditional reconfiguration candidate cell, and corresponding to the same conditional reconfiguration identifier. For example, the UE receives configuration information for conditional reconfiguration, and the first predetermined bit of the configuration information for conditional reconfiguration corresponding to the conditional reconfiguration identifier indicates the information associated with the RRM-based event and the second predetermined bit indicates the information associated with a location-based event.

In another embodiment, if the type of trigger event for conditional reconfiguration is an RRM-based event, and the type of the trigger event configured in combination with the RRM-based event is a location-based event, it indicates that the information of the RRM-based event and the location-based event may also be carried in different or the same reporting configuration information, or that the information of the RRM-based event and the location-based event may also be carried in different configuration information for conditional reconfiguration.

For example, the type of trigger event for conditional reconfiguration is conditional event A3, then the trigger event configured in combination with the conditional event A3 may be conditional event D1.

In an embodiment, if the type of trigger event for conditional reconfiguration is an RRM-based event, and the type of the trigger event configured in combination with this RRM-based event is an RRM-based event, it indicates that the information of this RRM-based event and an RRM-based event are associated in the same piece of configuration information for conditional reconfiguration, i.e., being associated with the same conditional reconfiguration candidate cell, and corresponding to the same conditional reconfiguration identifier. For example, the UE receives configuration information for conditional reconfiguration, and the first predetermined bit of the configuration information for conditional reconfiguration corresponding to the conditional reconfiguration identifier indicates the information associated with this RRM-based event and the second predetermined bit indicates the information associated with the RRM-based event.

In another embodiment, if the type of the trigger event for conditional reconfiguration is an RRM-based event, and the type of the trigger event configured in combination with this RRM-based event is an RRM-based event, it indicates that the information of this RRM-based event and the RRM-based event may also be carried in different or the same reporting configuration information, or that the information of this RRM-based event and the RRM-based event may also be carried in different configuration information for conditional reconfiguration.

Here, if the type of the trigger event for conditional reconfiguration is an RRM-based event and that the type of the trigger event configured in combination with this RRM-based event is also an RRM-based event, the type of this RRM-based event being the trigger event for conditional reconfiguration and the type of an RRM-based event configured in combination with this RRM-based event may be the same or different. For example, this RRM-based event being the trigger event for conditional reconfiguration is conditional event A3, then the trigger event configured in combination with the conditional event A3 may be conditional event A3. For another example, this RRM-based event being the trigger event for conditional reconfiguration is conditional event A3, then the trigger event configured in combination with the conditional event A3 may be conditional event A4.

In some embodiments, a time at which the UE performs a measurement operation is not earlier than a first time, and the first time is a time difference between a start time configured in the time-based event and a timeToTrigger (TTT) configured in the RRM-based event. The start time may be UTC time.

Here, the time when the UE performs the measurement operation may be UTC time.

For example, if the configured start time of the time-based event is T1 and the configured TTT of the RRM-based event is t, the first time is T1-t; the time when the UE performs the measurement operation may be the time of T1-t, or a time later than T1-t. For example, if the start time of the time-based event configured for the UE is 9 o'clock today and the TTT of the RRM-based event is 1 minute, the time when the UE performs the measurement operation is 8:59, or after 8:59.

Illustratively, in the above example, if a configured end time of the time-based event is T2, the time when the UE performs the measurement operation may be the time of T1-t, or the time after T1-t and before T2.

Here, the start time of the time-based event is a threshold1 of conditional event T1, and the end time of the time-based event is a threshold2 of conditional event T1.

For example, for each measId included in the measIdList in the VarMeasConfig, e.g., measId1:
if the reportType of the associated reportConfig is periodic measurement reporting, event-triggered measurement reporting, and/or,
if the reportType of the associated reportConfig is the condTriggerConfig, and the condEventId includes: conditional event A3 and/or conditional event A4 and/or conditional event A5;
if the event of another measId (e.g., measId2) associated with the same conditional reconfiguration as the measId is a time-based trigger event, e.g., conditional event T1, and the time measured by the UE is greater than or equal to Tx=t1_Threshold-TTT;
the measurement is performed.

Here, t1_Threshold represents the start time of conditional event T1, and TTT represents the TTT of conditional event A3 and/or conditional event A4 and/or conditional event A5.

In a possible implementation, the t1_Threshold is included in the reporting configuration associated with measId2; and the TTT is included in the reporting configuration associated with measId1.

As such, in the embodiment of the present disclosure, if the UE determines that the type of the trigger event for conditional reconfiguration is an RRM-based event and a time-based event, i.e., an RRM-based event and a time-based event configured in combination, the time at which the UE performs a measurement operation may be the time difference between the start time of the time-based event and the TTT of the RRM-based event or the time after the time difference, i.e., the UE may perform the measurement operation in advance of the TTT. In this way, the measurement may be performed in advance, and the impact on the TTT for conditional reconfiguration is reduced, thereby improving the measurement efficiency of conditional reconfiguration while ensuring the performance to a certain extent.

Certainly, in other embodiments, if the type of trigger event of the UE for conditional reconfiguration is an RRM-based event and a time-based event, the time when the UE performs the measurement operation is the start time of the time-based event or later than the start time, or the time when the UE performs the measurement operation is the time between the start time of the time-based event and the end time of the time-based event.

It should be noted that, those skilled in the art may understand that, the method provided in the embodiments of the present disclosure may be executed individually, or may be executed together with some methods in the embodiments of the present disclosure or some methods in related art.

The step S21 may include one of the following:
based on that the type of the trigger event for measurement reporting is an RRM-based event, determining that the UE performs a measurement operation for the trigger event;
based on that the type of the trigger event for measurement reporting is not an RRM-based event, determining that the UE does not perform a measurement operation for the trigger event; and
based on the type of the trigger event for measurement reporting and a measurement result needing to be reported, determining a measurement operation of the UE for the trigger event.

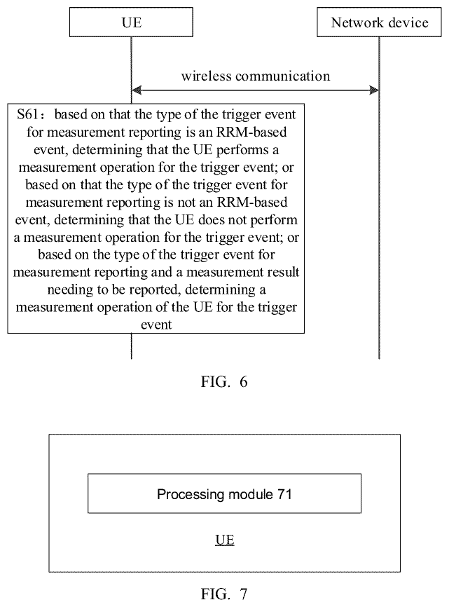

As illustrated in FIG. 6, a measurement method is provided by embodiments of the present disclosure, performed by a UE, which includes:

In step S61: based on that the type of the trigger event for measurement reporting is an RRM-based event, determining that the UE performs a measurement operation for the trigger event; or based on that the type of the trigger event for measurement reporting is not an RRM-based event, determining that the UE does not perform a measurement operation for the trigger event; or based on the type of the trigger event for measurement reporting and a measurement result needing to be reported, determining a measurement operation of the UE for the trigger event.

In some embodiments of the present disclosure, the type of the trigger event for measurement reporting is the type of the trigger event for measurement reporting in the above embodiments; the measurement operation for the trigger event is the measurement operation for the trigger event in step S21; and the RRM-based event is the RRM-based measurement reporting event in the above embodiments; the time-based event is the time-based measurement reporting event in the above embodiments; and the location-based event is the location-based measurement reporting event in the above embodiments.

The type of the trigger event for measurement reporting is not an RRM-based event, includes but is not limited to at least one of the following:
the type of the trigger event for measurement reporting is a time-based event; and
the type of the trigger event for measurement reporting is a location-based event.

The embodiments of the present disclosure provides a measurement method, performed by a UE, which includes: based on that the type of the trigger event for measurement reporting is a time-based event, determining that the UE does not perform a measurement operation for the trigger event; or based on the type of the trigger event for measurement reporting is a location-based or a distance-based event, determining that the UE does not perform a measurement operation for the trigger event.

The embodiments of the present disclosure provides a measurement method, performed by a UE, which includes: based on that the type of the trigger event for measurement reporting associated with a measId is a time-based event, determining that the UE does not perform a measurement operation for the trigger event associated with the measId; based on that the type of the trigger event for conditional reconfiguration associated with a measId is a location-based or distance-based event, determining that the UE does not perform a measurement operation for the trigger event associated with the measId.

As such, in the embodiments of the present disclosure, the method may determine whether to perform a measurement operation for the trigger event by determining, through the UE, whether the type of the trigger event for measurement reporting is an RRM-based event; if determining that the type of the trigger event for measurement reporting is an RRM-based event, it is determined to perform a measurement operation for the RRM-based event; if determining the type of the trigger event for measurement reporting is not an RRM-based event, i.e., a time-based event, or a location-based or distance-based event, it is determined not to perform a measurement operation for the time-based event, or the location-based or distance-based event. As such, the measurement opportunities of the UE may be flexibly adjusted. For example, if an RRM-based measurement reporting event is configured, the measurement for the RRM-based measurement reporting event may be directly performed; if a time-based or location-based or distance-based measurement reporting event is configured, the measurement for the time-based or location-based or distance-based measurement reporting event is not performed, so as to increase opportunities for other measurement objects that need to be measured.

Based on the type of the trigger event for measurement reporting and a measurement result needing to be reported, determining a measurement operation of the UE for the trigger event includes: based on that the type of the trigger event for measurement reporting is not an RRM-based event and the measurement result needing to be reported does not include a measurement result of a measured cell, determining that the UE does not perform a measurement operation for the trigger event.

The embodiments of the present disclosure provides a measurement method, performed by a UE, which may include: based on that the type of the trigger event for measurement reporting is not an RRM-based event and the measurement result needing to be reported does not include a measurement result of a measured cell, determining that the UE does not perform a measurement operation for the trigger event.

For example, for each measId included in the measIdList in the VarMeasConfig:
if the reportType of the associated reportConfig is a trigger event for measurement reporting, and the condEventId is event A1, event A2, event A3, event A4, event A5, event A6, event B1, event B2, or event tl1; and/or,
if the reportType of the associated reportConfig is event-triggered measurement reporting and the condEventId is event T1 and the reporting configuration associated with the measId indicates that a measurement result of the measured cell needs to be included;
the measurement is performed.

The condEventId here refers to a type of a trigger event for measurement reporting.

The measured cell includes but is not limited to a serving cell and/or a neighboring cell. The measured cell may also include, but is not limited to, a PCell, a SCell, and a PSCell.

Here, the information indicating the measurement result needing to be reported may be carried in the reporting configuration information in the above embodiments, or the measurement result that UE needs to report may be indicated by other configuration information.

For example, the UE receives a radio resource control (RRC) signaling from a network device, and the RRC signaling carries indication information which instructs the UE not to report the measurement result of the measured cell. For example, RRC reporting information element (IE) carries indication information, which instructs the UE to report the measurement result of the measured cell; or RRC reporting information element does not carry indication information, which instructs the UE not to report the measurement result of the measured cell.

As such, in the embodiment of the present disclosure, the method may, through the UE determining the type of the trigger event for measurement reporting and a measurement result needing to be reported, determine whether to perform the measurement operation for the trigger event. For example, if the UE determines that the type of the trigger event for measurement reporting is not an RRM-based event (i.e., a time-based or location-based event) and the measurement result needing to be reported does not include the measurement result of the measured cell, it is not necessary to perform a measurement for the time-based or location-based event. Such approach may increase opportunities for other measurement objects that need to be measured, thereby improving the measurement efficiency.

In some embodiments, for each measurement object, if the reporting configuration information associated with the measurement object is reporting configuration information including the type of the trigger event for conditional reconfiguration, the UE may determine the measurement operation for the measurement object based on the type of the trigger event for conditional reconfiguration, or the UE may determine the measurement operation for the measurement object based on the type of the trigger event for conditional reconfiguration and the type of a trigger event configured in combination with the trigger event for conditional reconfiguration; and/or, for each measurement object, if the reporting configuration information associated with the measurement object is reporting configuration information including the type of trigger event for measurement reporting, the UE may determine the measurement operation for the measurement object based on the type of the trigger event for measurement reporting.

In an embodiment, the measurement operation of the measurement object includes the measurement operation of the frequency point corresponding to the measurement object. The measurement operation of the frequency point corresponding to the measurement object may be: the measurement operation of one or more measured cells of the frequency point corresponding to the measurement object.

It should be noted that, those skilled in the art may understand that, the method provided in the embodiments of the present disclosure may be executed individually, or may be executed together with some methods in the embodiments of the present disclosure or some methods in related art.

In order to further explain any embodiment of the present disclosure, a specific embodiment is provided below.

A measurement method is provided by embodiments of the present disclosure, performed by a UE, which includes the following steps:

In step S71: based on the type of the trigger event associated with a measurement identifier, determining a measurement operation of the UE for the trigger event associated with the measurement identifier;

The step S71 includes the steps S71a, S71b or S71c described as below.

In step S71a: based on the type of the trigger event for conditional reconfiguration associated with a measurement identifier, determining a measurement operation of the UE for the trigger event associated with the measurement identifier;
the step S71a includes:

In step S71al: based on that the type of the trigger event for conditional reconfiguration associated with a measurement identifier is an RRM-based event, determining that the UE performs a measurement operation for the trigger event associated with the measurement identifier;
or,
in step S71a2: based on that the type of the trigger event for conditional reconfiguration associated with a measurement identifier is not an RRM-based event, determining that the UE does not perform a measurement operation for the trigger event associated with the measurement identifier.

The step S71a2 includes:
based on that the type of the trigger event for conditional reconfiguration associated with a measurement identifier is a time-based event, determining that the UE does not perform a measurement operation for the trigger event associated with the measurement identifier;
and/or,
based on that the type of the trigger event for conditional reconfiguration associated with a measurement identifier is a location-based event, determining that the UE does not perform a measurement operation for the trigger event associated with the measurement identifier.

In step S71b: based on the type of the trigger event for conditional reconfiguration associated with a measurement identifier and the type of the trigger event configured in combination with the trigger event for conditional reconfiguration, determining a measurement operation of the UE for the trigger event associated with the measurement identifier.

The step S71b includes at least one of the following:

In step S71b1: based on that the type of the trigger event for conditional reconfiguration associated with a measurement identifier is an RRM-based event and that the type of the trigger event configured in combination with the RRM-based event is a time-based event, in response to whether the UE meets the time-based event, determining a measurement operation of the UE for the trigger event associated with the measurement identifier;
in step S71b2: based on that the type of the trigger event for conditional reconfiguration associated with a measurement identifier is an RRM-based event and that the type of the trigger event configured in combination with the RRM-based event is a location-based event, in response to whether the UE meets the location-based event, determining a measurement operation of the UE for the trigger event associated with the measurement identifier;
in step S71b3: based on that the type of the trigger event for conditional reconfiguration associated with a measurement identifier is an RRM-based event and that the type of the trigger event configured in combination with the RRM-based event is an RRM-based event, determining that the UE performs a measurement operation for the trigger event associated with the measurement identifier.

Here, the location-based event is a distance-based event.

The step S71b1 includes:
based on that the type of the trigger event for conditional reconfiguration associated with a measurement identifier is an RRM-based event and that the type of the trigger event configured in combination with the RRM-based event is a time-based event, if the UE meets the time-based event, determining that the UE performs a measurement operation for the trigger event associated with the measurement identifier;
or,
based on that the type of the trigger event for conditional reconfiguration associated with a measurement identifier is an RRM-based event and that the type of the trigger event configured in combination with the RRM-based event is a time-based event, if the UE does not meet the time-based event, determining that the UE does not perform a measurement operation for the trigger event associated with the measurement identifier.

The step S71b2 includes:
based on that the type of the trigger event for conditional reconfiguration associated with a measurement identifier is an RRM-based event and that the type of the trigger event configured in combination with the RRM-based event is a location-based event, if the UE meets the location-based event, determining that the UE performs a measurement operation for the trigger event associated with the measurement identifier;
or,
based on that the type of the trigger event for conditional reconfiguration associated with a measurement identifier is an RRM-based event and that the type of the trigger event configured in combination with the RRM-based event is a location-based event, if the UE does not meet the location-based event, determining that the UE does not perform a measurement operation for the trigger event associated with the measurement identifier.

The conditional reconfiguration included in the above steps S71a and S71b may be at least one of the following: CHO, CPC, and CPA.

The RRM-based event included in the above steps S71a and S71b may be at least one of the following: conditional event A3, conditional event A4, and conditional event A5.

The time-based event included in the above steps S71a and S71b may be: conditional event T1; and the location-based event included in the above step S71 may be: conditional event D1.

In step S71c: based on the type of the trigger event for measurement reporting associated with a measurement identifier, determining a measurement operation of the UE for the trigger event associated with the measurement identifier.

The step S71c includes:
in step S71cl: based on that the type of the trigger event for measurement reporting associated with a measurement identifier is an RRM-based event, determining that the UE performs a measurement operation for the trigger event associated with the measurement identifier;
in step S71c2: based on that the type of the trigger event for measurement reporting associated with a measurement identifier is not an RRM-based event, determining that the UE does not perform a measurement operation for the trigger event associated with the measurement identifier.

The step S71c2 includes:
based on that the type of the trigger event for measurement reporting associated with a measurement identifier is a time-based event, determining that the UE does not perform a measurement operation for the trigger event associated with the measurement identifier;
or,
based on that the type of the trigger event for measurement reporting associated with a measurement identifier is a location-based event, determining that the UE does not perform a measurement operation for the trigger event associated with the measurement identifier.

The RRM-based event included in the above step S71c may be at least one of the following: event A1, event A2, event A3, event A4, event A5, event B1, and event B2.

The time-based event included in the above step S71c may be event T1; and the location-based event included in the above step S71 may be event D1.

The measurement operation for the trigger event associated with the measurement identifier, included in the above step S71, includes at least one of the following: the measurement operation determined based on the reporting configuration information associated with the measurement identifier; and the measurement operation of the measurement object associated with the measurement identifier, where the reporting configuration information includes the configuration of the trigger event. Here, the measurement operation determined based on the reporting configuration information associated with the measurement identifier includes but is not limited to: a measurement operation corresponding to a measurement reference signal needing to be measured and determined according to the reporting configuration information associated with the measurement identifier and a measurement operation of the measurement object associated with the measurement identifier; wherein the reporting configuration information includes the configuration of the trigger event. Here, the measurement operation determined based on the reporting configuration information associated with the measurement identifier includes but is not limited to: a measurement operation corresponding to a measurement reference signal needing to be measured and determined according to the reporting configuration information associated with the measurement identifier and/or a measurement operation of a measurement quantity needing to be measured and determined according to the reporting configuration information. The measurement operation of a measurement object associated with the measurement identifier includes but is not limited to: a measurement operation of a frequency point, a cell, and/or a measurement reference signal associated with the measurement identifier.

As illustrated in FIG. 7, a measurement apparatus is provided in embodiments of the present disclosure, applied to a UE, which includes:
a processing module 71, configured to determine, based on a type of a trigger event, a measurement operation of the UE for the trigger event.

In some embodiments, a measurement operation for the trigger event includes at least one of the following:
a measurement operation determined based on reporting configuration information, where the reporting configuration information includes a configuration of the trigger event;
a measurement operation of a measurement object associated with the reporting configuration information, where the measurement object is associated with the trigger event, or the measurement object is associated with the reporting configuration information including the configuration of the trigger event.

The embodiments of the present disclosure provides a measurement apparatus, applied to a UE, which may include: a processing module 71, configured to determine, based on the type of the trigger event associated with a measurement identifier, a measurement operation of the UE for the trigger event associated with the measurement identifier.

In some embodiments, the measurement operation of the trigger event associated with the measurement identifier includes at least one of the following:
a measurement operation determined based on reporting configuration information associated with the measurement identifier;
a measurement operation of a measurement object associated with the measurement identifier;
where the reporting configuration information includes a configuration of the trigger event.

In some embodiments, the type of a trigger event includes at least one of the following:
a type of a trigger event for conditional reconfiguration;
a type of a trigger event for measurement reporting.

The embodiments of the present disclosure provides a measurement apparatus, applied to a UE, which may include: a processing module 71, configured to determine, based on the type of the trigger event for conditional reconfiguration, a measurement operation of the UE for the trigger event.

The embodiments of the present disclosure provides a measurement apparatus, applied to a UE, which may include: a processing module 71, configured to determine, based on the type of the trigger event for measurement reporting, a measurement operation of the UE for the trigger event.

The embodiments of the present disclosure provides a measurement apparatus, applied to a UE, which may include: a processing module 71, configured to determine, based on that the type of the trigger event for conditional reconfiguration is an RRM-based event, that the UE performs a measurement operation for the trigger event.

The embodiments of the present disclosure provides a measurement apparatus, applied to a UE, which may include: a processing module 71, configured to determine, based on that the type of the trigger event for conditional reconfiguration is not an RRM-based event, that the UE does not perform a measurement operation for the trigger event.

In some embodiments, the type of the trigger event for conditional reconfiguration is not an RRM-based event, includes at least one of the following:
the type of the trigger event for conditional reconfiguration is a location-based event;
the type of the trigger event for conditional reconfiguration is a time-based event.

The embodiments of the present disclosure provides a measurement apparatus, applied to a UE, which may include: a processing module 71, configured to determine, based on that the type of the trigger event for conditional reconfiguration is a location-based event, that the UE does not perform a measurement operation for the trigger event.

The embodiments of the present disclosure provides a measurement apparatus, applied to a UE, which may include: a processing module 71, configured to determine, based on that the type of the trigger event for conditional reconfiguration is a time-based event, that the UE does not perform a measurement operation for the trigger event.

The embodiments of the present disclosure provides a measurement apparatus, applied to a UE, which may include: a processing module 71, configured to, based on that the type of the trigger event for conditional reconfiguration is an RRM-based event and a location-based event, in response to whether the UE meets the location-based event, determine a measurement operation of the UE for the trigger event.

The embodiments of the present disclosure provides a measurement apparatus, applied to a UE, which may include: a processing module 71, configured to, based on that the type of the trigger event for conditional reconfiguration is an RRM-based event and a time-based event, in response to whether the UE meets the time-based event, determine a measurement operation of the UE for the trigger event.

The embodiments of the present disclosure provides a measurement apparatus, applied to a UE, which may include: a processing module 71, configured to, based on that the type of the trigger event for conditional reconfiguration is two RRM-based events configured in combination, determine that the UE performs a measurement operation for the trigger event.

The embodiments of the present disclosure provides a measurement apparatus, applied to a UE, which may include: a processing module 71, configured to, based on that the type of the trigger event for conditional reconfiguration is an RRM-based event and that the type of the trigger event configured in combination with the RRM-based event is an RRM-based event, determine that the UE performs a measurement operation for the trigger event.

The embodiments of the present disclosure provides a measurement apparatus, applied to a UE, which may include: a processing module 71, configured to, based on the type of a trigger event for conditional reconfiguration and the type of the trigger event configured in combination with the trigger event for conditional reconfiguration, determine a measurement operation of the UE for the trigger event.

The embodiments of the present disclosure provides a measurement apparatus, applied to a UE, which may include: a processing module 71, configured to, based on that the type of the trigger event for conditional reconfiguration is an RRM-based event and that the type of the trigger event configured in combination with the RRM-based event is a time-based event, in response to whether the UE meets the time-based event, determine a measurement operation of the UE for the trigger event.

The embodiments of the present disclosure provides a measurement apparatus, applied to a UE, which may include: a processing module 71, configured to, based on that the type of the trigger event for conditional reconfiguration is an RRM-based event and that the type of the trigger event configured in combination with the RRM-based event is a location-based event, in response to whether the UE meets the location-based event, determine a measurement operation of the UE for the trigger event.

The embodiments of the present disclosure provides a measurement apparatus, applied to a UE, which may include: a processing module 71, configured to, based on that the UE meets the location-based event, determine that the UE performs a measurement operation for the measurement event; or the processing module 71, configured to, based on that the UE does not meet the location-based event, determine that the UE does not perform a measurement operation for the trigger event.

The embodiments of the present disclosure provides a measurement apparatus, applied to a UE, which may include: a processing module 71, configured to, based on that the type of the trigger event for conditional reconfiguration is an RRM-based event and a location-based event, in response to that the UE meets the location-based event, determine that the UE performs a measurement operation for the measurement event; or a triggering module 61, configured to, based on that the type of the trigger event for conditional reconfiguration is an RRM-based event and a location-based event, in response to that the UE does not meet the location-based event, determine that the UE does not perform a measurement operation for the trigger event.

The embodiments of the present disclosure provides a measurement apparatus, applied to a UE, which may include: a processing module 71, configured to, based on that the UE meets a time-based event, determine that the UE performs a measurement operation for the trigger event; or configured to determine, based on that the UE does not meet a time-based event, that the UE does not perform a measurement operation for the trigger event;

The embodiments of the present disclosure provides a measurement apparatus, applied to a UE, which may include: a processing module 71, configured to, based on that the type of the trigger event for conditional reconfiguration is an RRM-based event and a time-based event, in response to that the UE meets the time-based event, determine that the UE performs a measurement operation for the trigger event; or a triggering module 61, configured to, based on that the type of the trigger event for conditional reconfiguration is an RRM-based event and a time-based event, in response to that the UE does not meet the time-based event, determine that the UE does not perform a measurement operation for the trigger event.

In some embodiments, a time at which the UE performs the measurement operation is not earlier than a first time, and the first time is a time difference between a start time configured in the time-based event and a TTT configured in the RRM-based event.

Here, the time refers to the measurement time when the UE performs the measurement operation.

The embodiments of the present disclosure provides a measurement apparatus, applied to a UE, which may include: a processing module 71, configured to, based on that the type of the trigger event for measurement reporting is an RRM-based event, determine that the UE performs a measurement operation for the trigger event.

The embodiments of the present disclosure provides a measurement apparatus, applied to a UE, which may include: a processing module 71, configured to, based on that the type of the trigger event for measurement reporting is not an RRM-based event, determine that the UE does not perform a measurement operation for the trigger event.

The embodiments of the present disclosure provides a measurement apparatus, applied to a UE, which may include: a processing module 71, configured to, based on the type of the trigger event for measurement reporting and a measurement result needing to be reported, determine a measurement operation of the UE for the trigger event.

The embodiments of the present disclosure provides a measurement apparatus, applied to a UE, which may include: a processing module 71, configured to, based on that the type of the trigger event for measurement reporting is not an RRM-based event and the measurement result needing to be reported does not include a measurement result of a measured cell, determine that the UE does not perform a measurement operation for the trigger event.

In some embodiments, the type of the trigger event for measurement reporting is not an RRM-based event, which includes:
the type of the trigger event for measurement reporting is a time-based event;
the type of the trigger event for measurement reporting is a location-based event.

The embodiments of the present disclosure provides a measurement apparatus, applied to a UE, which may include: a processing module 71, configured to, based on that the type of the trigger event for measurement reporting is a time-based event and the measurement result needing to be reported does not include a measurement result of a measured cell, determine that the UE does not perform a measurement operation for the trigger event.

The embodiments of the present disclosure provides a measurement apparatus, applied to a UE, which may include: a processing module 71, configured to, based on that the type of the trigger event for measurement reporting is a location-based event and the measurement result needing to be reported does not include a measurement result of a measured cell, determine that the UE does not perform a measurement operation for the trigger event.

It should be noted that, those skilled in the art may understand that, the method provided in the embodiments of the present disclosure may be executed individually, or may be executed together with some methods in the embodiments of the present disclosure or some methods in related art.

Specific manners for devices in the apparatus in the foregoing embodiment to perform operations have been described in detail in the embodiments of the method. Details are not described herein again.

The embodiments of the present disclosure provides a communication device, which includes:
one or more processors; and
a storage for storing instructions executable by the processor;
where the one or more processors are configured to perform the measurement method in any embodiment of the present disclosure when running the executable instructions.

In an embodiment, the communication device may be a base station or a UE.

Wherein the processor may include various types of storage media, which are non-transitory computer storage media that may continue to memorize information stored thereon after the user device loses power.

The one or more processors may be connected to the storage via a bus or the like, and may be used to read an executable program stored in the storage, for example, referring to at least one of the methods as illustrated in FIGS. 2 to 6.

The embodiments of the present disclosure provides a computer storage medium, which stores a computer-executable program, the measurement method in any embodiment of the present disclosure is performed when the executable program is executed by one or more processors. For example, the method is at least one of the methods as illustrated in FIGS. 2 to 6.

Regarding the apparatus or the storage medium in the above embodiments, the specific manner in which each module performs operations has been described in detail in the embodiments related to the method, which will not be elaborated herein.

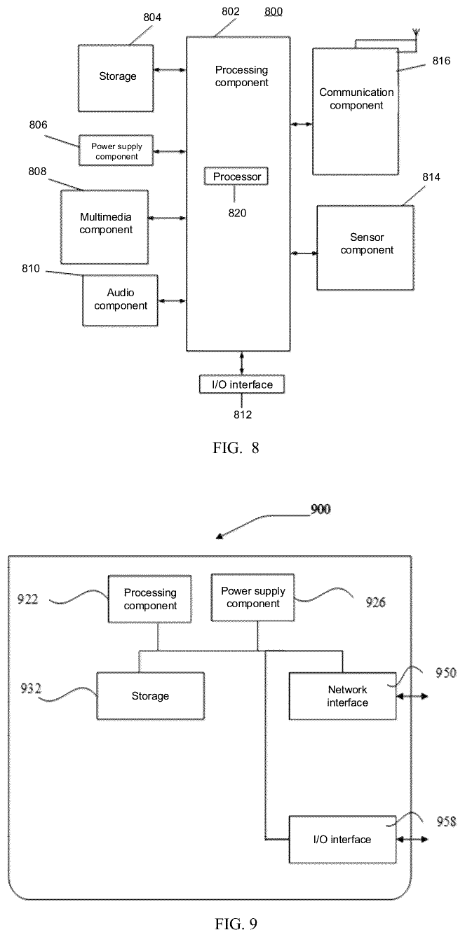

FIG. 8 is a block diagram illustrating a UE 800 according to an embodiment. For example, the UE 800 may be a mobile phone, a computer, a digital broadcast user device, a messaging device, a game console, a tablet device, a medical device, a fitness device, a personal digital assistant, etc.

Referring to FIG. 8, the UE 800 may include one or more of the following components: a processing component 802, a storage 804, a power supply component 806, a multimedia component 808, an audio component 810, an input/output (I/O) interface 812, a sensor component 814, and a communication component 816.

The processing component 802 generally controls the overall operation of the UE 800, such as operations associated with displays, phone calls, data communications, camera operations, and recording operations. The processing component 802 may include one or more processors 820 to execute instructions to complete all or a part of the blocks of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The storage 804 is configured to store different types of data to support operations on the UE 800. Examples of such data include instructions of any application program or method operated on the UE 800, contact data, phone book data, messages, pictures, videos, etc. The storage 804 may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 806 provides power to various components of the UE 800. The power supply component 806 may include a power supply management system, one or more power supplies, and other components associated with generating, managing and distributing power for the UE 800.

The multimedia component 808 includes a screen for providing an output interface between the UE 800 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of an action of a touch or swipe, but further sense a duration and a pressure associated with the touch or swipe. In some examples, the multimedia component 808 may include a front camera and/or a rear camera. When the UE 800 is in an operating mode, such as a shooting mode or a video mode, the front camera and/or the rear camera may receive external multimedia data. Each of the front camera and the rear camera may be a fixed optical lens system or have focal length and optical zooming capability.

The audio component 810 is configured to output and/or input an audio signal. For example, the audio component 810 includes a microphone (MIC). If the UE 800 is in an operating mode, such as a call mode, a recording mode, and a speech recognition mode, the microphone is configured to receive an external audio signal. The received audio signal may be further stored in the storage 804 or sent via the communication component 816. In some examples, the audio component 810 also includes a speaker for outputting an audio signal.

The I/O interface 812 may provide an interface between the processing component 802 and a peripheral interface module. The above peripheral interface module may be a keyboards, click wheels, buttons and so on. These buttons may include but not limited to, a home button, a volume button, a start button and a lock button.

The sensor component 814 may include one or more sensors for providing state assessments in different aspects for the UE 800. For example, the sensor component 814 may detect the on/off state of the UE 800, and relative locations of components, for example, the component is a display and a small keyboard of the UE 800. The sensor component 814 may also detect a change of the position of the UE 800 or a component of the UE 800, the presence or absence of contact of a user with the UE 800, an orientation or acceleration/deceleration of the UE 800 and a change in the temperature of the UE 800. The sensor component 814 may include a proximity sensor for detecting the existence of a nearby object without any physical touch. The sensor component 814 may also include an optical sensor such as a complementary metal oxide semiconductor (CMOS) or a charged coupled device (CCD) image sensor used for imaging application. In some examples, the sensor component 814 may also include an acceleration sensor, a gyro sensor, a magnetic sensor, a pressure sensor, or a temperature sensor.

The communication component 816 is configured to facilitate wired or wireless communications between the UE 800 and other devices. The UE 800 may access a wireless network based on a communication standard, such as WIFI, 4G or 5G, or a combination thereof. In an exemplary example, the communication component 816 receives a broadcast signal or broadcast related information from an external broadcast management system via a broadcast channel. In an exemplary example, the communication component 816 may also include a near field communication (NFC) module to facilitate short-range communications. For example, the NFC module may be implemented based on a radio frequency identification (RFID) technology, an Infrared Data Association (IrDA) technology, an ultra wideband (UWB) technology, a Bluetooth (BT) technology and other technologies.

In exemplary embodiments, the UE 800 may be implemented by one or more of an application-specific integrated circuit (ASIC), a digital signal processor (DSP), a digital signal processing device (DSPD), a programmable logical device (PLD), a field programmable gate array (FPGA), a controller, a microcontroller, a microprocessor or other electronic components to execute the above methods.

In exemplary examples, a non-transitory machine readable storage medium storing machine executable instructions is provided, e.g., the storage 804 storing instructions, and the instructions may be executed by the processors 820 of the UE 800 to complete the above method. For example, the non-transitory computer readable storage medium may be a ROM, a random access memory (RAM), a CD-ROM, a magnetic tape, a floppy disk and an optical data storage device, etc.

As illustrated in FIG. 9, an embodiment of the present disclosure illustrates a structure of a base station. For example, the base station 900 may be provided as a network device. Referring to FIG. 9, the base station 900 includes: a processing component 922, which further includes one or more processors, and a storage resource represented by a storage 932, used for storing instructions executable by the processing component 922, e.g., an application. The application stored in the storage 932 may include one or more modules, each of which corresponds to a set of instructions. In addition, the processing component 922 is configured to execute instructions, to perform any method performed by the base station as described above.

The base station 900 may further include: a power supply component 926, configured to manage power supply of the base station 900, a wired or wireless network interface 950 configured to connect the base station 900 to a network, and an I/O interface 958. The base station 900 may operate based on an operating system stored in the storage 932, such as Windows Server™, Mac OS X™, Unix™, Linux™, FreeBSD™, etc.

Other embodiments of the present disclosure will be readily apparent to those skilled in the art after considering the specification and practicing the contents disclosed herein. The present application is intended to cover any variations, uses, or adaptations of the present disclosure, which follow the general principle of the present disclosure and include common knowledge or conventional technical means in the art that are not disclosed in the present disclosure. The specification and examples are to be regarded as illustrative only. The true scope and spirit of the present disclosure are pointed out by the following claims.

It is to be understood that the present disclosure is not limited to the precise structures described above and shown in the accompanying drawings and may be modified or changed without departing from the scope of the present disclosure. The scope of the present disclosure is limited only by the appended claims.

1. A measurement method, performed by a user equipment (UE), comprising:
determining, based on a type of a trigger event, a measurement operation of the UE for the trigger event.

2. The measurement method according to claim 1, wherein determining, based on the type of the trigger event, the measurement operation of the UE for the trigger event comprises:
determining, based on the type of the trigger event associated with a measurement identifier, the measurement operation of the UE for the trigger event associated with the measurement identifier.

3. The measurement method according to claim 2, wherein the measurement operation for the trigger event associated with the measurement identifier comprises at least one of:
the measurement operation determined based on reporting configuration information associated with the measurement identifier, wherein the reporting configuration information comprises a configuration of the trigger event; or
the measurement operation of a measurement object associated with the measurement identifier, wherein the measurement object is associated with the trigger event, or the measurement object is associated with the reporting configuration information including the configuration of the trigger event.

4. The measurement method according to claim 1, wherein the type of the trigger event comprises at least one of:
a type of the trigger event for conditional reconfiguration; or
a type of the trigger event for measurement reporting.

5. The measurement method according to claim 4, wherein determining, based on the type of the trigger event, the measurement operation of the UE for the trigger event comprises at least one of:
based on that the type of the trigger event for conditional reconfiguration is a radio resource management (RRM)-based event, determining that the UE performs the measurement operation for the trigger event; or
based on that the type of the trigger event for conditional reconfiguration is not the RRM-based event, determining that the UE does not perform the measurement operation for the trigger event.

6. The measurement method according to claim 5, wherein the type of the trigger event for conditional reconfiguration is not the RRM-based event comprises at least one of:
the type of the trigger event for conditional reconfiguration is a location-based event; or
the type of the trigger event for conditional reconfiguration is a time-based event.

7. The measurement method according to claim 4, wherein determining, based on the type of the trigger event, the measurement operation of the UE for the trigger event comprises at least one of:
based on that the type of the trigger event for conditional reconfiguration is an RRM-based event and a location-based event, in response to whether the UE meets the location-based event, determining the measurement operation of the UE for the trigger event;
based on that the type of the trigger event for conditional reconfiguration is the RRM-based event and a time-based event, in response to whether the UE meets the time-based event, determining the measurement operation of the UE for the trigger event; or
based on that the type of the trigger event for conditional reconfiguration is two RRM-based events configured in combination, determining that the UE performs the measurement operation for the trigger event.

8. The measurement method according to claim 7, wherein in response to whether the UE meets the location-based event, determining the measurement operation of the UE for the trigger event comprises at least one of:
in response to that the UE meets the location-based event, determining that the UE performs the measurement operation for the trigger event; or
in response to that the UE does not meet the location-based event, determining that the UE does not perform the measurement operation for the trigger event.

9. The measurement method according to claim 7, wherein in response to whether the UE meets the time-based event, determining the measurement operation of the UE for the trigger event comprises at least one of:
in response to that the UE meets the time-based event, determining that the UE performs the measurement operation for the trigger event; or
in response to that the UE does not meet the time-based event, determining that the UE does not perform the measurement operation for the trigger event.

10. The measurement method according to claim 7, wherein a time at which the UE performs the measurement operation is not earlier than a first time, and the first time is a time difference between a start time configured in the time-based event and a timetotrigger (TTT) configured in the RRM-based event.

11. The measurement method according to claim 4, wherein determining, based on the type of the trigger event, the measurement operation of the UE for the trigger event, comprises at least one of:
based on that the type of the trigger event for measurement reporting is an RRM-based event, determining that the UE performs the measurement operation for the trigger event;
based on that the type of the trigger event for measurement reporting is not the RRM-based event, determining that the UE does not perform the measurement operation for the trigger event; or
based on the type of the trigger event for measurement reporting and a measurement result needing to be reported, determining the measurement operation of the UE for the trigger event.

12. The measurement method according to claim 11, wherein based on the type of the trigger event for measurement reporting and the measurement result needing to be reported, determining the measurement operation of the UE for the trigger event comprises:
based on that the type of the trigger event for measurement reporting is not the RRM-based event and that the measurement result needing to be reported does not include the measurement result of a measured cell, determining that the UE does not perform the measurement operation for the trigger event.

13. The measurement method according to claim 11, wherein the type of the trigger event for measurement reporting is not the RRM-based event, comprises at least one of:
the type of the trigger event for measurement reporting is a time-based event; or
the type of the trigger event for measurement reporting is a location-based event.

14.-26. (canceled)

27. A communication device, comprising:
one or more processors; and
a storage for storing processor-executable instructions;
wherein the one or more processors are collectively configured to:
determine, based on a type of a trigger event, a measurement operation of a UE for the trigger event.

28. A non-transitory computer storage medium storing a computer-executable program, when the executable program is executed by one or more processors, the executable program cause the one or more processors to collectively execute the measurement method according to claim 1.

29. The communication device according to claim 27, wherein determining, based on the type of the trigger event, the measurement operation of the UE for the trigger event comprises:
determining, based on the type of the trigger event associated with a measurement identifier, the measurement operation of the UE for the trigger event associated with the measurement identifier.

30. The communication device according to claim 29, wherein the measurement operation for the trigger event associated with the measurement identifier comprises at least one of:
the measurement operation determined based on reporting configuration information associated with the measurement identifier, wherein the reporting configuration information comprises a configuration of the trigger event;
the measurement operation of a measurement object associated with the measurement identifier, wherein the measurement object is associated with the trigger event, or
the measurement object is associated with the reporting configuration information including the configuration of the trigger event.

31. The communication device according to claim 27, wherein the type of the trigger event comprises at least one of:
a type of the trigger event for conditional reconfiguration;
a type of the trigger event for measurement reporting.

32. The communication device according to claim 31, wherein determining, based on the type of the trigger event, the measurement operation of the UE for the trigger event comprises at least one of:
based on that the type of the trigger event for conditional reconfiguration is a radio resource management (RRM)-based event, determining that the UE performs the measurement operation for the trigger event;
based on that the type of the trigger event for conditional reconfiguration is not the RRM-based event, determining that the UE does not perform the measurement operation for the trigger event.

33. The communication device according to claim 32, wherein the type of the trigger event for conditional reconfiguration is not the RRM-based event comprises at least one of:
the type of the trigger event for conditional reconfiguration is a location-based event;
the type of the trigger event for conditional reconfiguration is a time-based event.
